(19) United States
(12) Patent Application Publication
(10) Pub. No.: US 2021/0215729 A1
(43) Pub. Date: Jul. 15, 2021

(54) DEVICES, SYSTEMS AND METHODS FOR DETERMINING CONCENTRATIONS OF OXYGEN AND CARBON DIOXIDE FROM COMBUSTION SOURCES

(71) Applicant: Charles Sneeringer, Gainesville, FL (US)

(72) Inventor: Charles Sneeringer, Gainesville, FL (US)

(21) Appl. No.: 16/739,999

(22) Filed: Jan. 10, 2020

(51) Int. Cl. G01N 35/00

(52) U.S. Cl. CPC G01N 35/00623; G01N 2035/00891; G01N 35/00722

(57) ABSTRACT

A portable oxygen and carbon dioxide analyzer device includes a lightweight housing with physical dimensions rendering the analyzer device portable. The analyzer device meets Environmental Protection Agency (EPA) and International Organization for Standardization (ISO) criteria for linearity, repeatability, and response time. The analyzer device can be used for emissions testing without the need of a temperature controlled environment. The analyzer device is meant to be used at the testing location which can be hundreds of feet (meters) above ground level. The analyzer device is light weight and physically small to facilitate transportation to the testing location. The analyzer device uses an algorithm programed into its digital controller to compensate for ambient temperature and pressure fluctuations during the testing procedure. The analyzer device has analog and digital outputs and internal data logging capabilities to facilitate calibration and monitoring of flue gas component concentrations.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND

The disclosure relates generally to a portable oxygen and carbon dioxide analyzer for emissions testing and determining concentrations of oxygen and carbon dioxide from combustion sources. More specifically, the disclosure relates to a compact, lightweight, digitally controlled analyzer system and device that is capable of reading oxygen and carbon dioxide levels without the need for temperature or pressure-controlled environments, having analog and digital outputs as well as data logging capabilities to facilitate calibration and monitoring of oxygen and carbon dioxide concentrations.

Current devices for oxygen and carbon dioxide analyzer machines are, generally, not light weight and are not easily transportable devices, which can operate under varying environmental conditions. Many oxygen and carbon dioxide analyzer machines available today are relatively large and are intended for use in a laboratory type settings. Smaller devices currently available are generally intended for source measurements, but do not have features to facilitate their use involving regulatory applications.

Thus, the difficulty of utilizing portable, lightweight, analyzers to be used in regulatory applications presents significant difficulties for oxygen and carbon dioxide on site flue gas emissions testing and the like. The claimed subject matter is not limited to embodiments that solve any disadvantages or that operate only in environments such as those described above. This background is only provided to illustrate examples of where the present disclosure may be utilized.

### SUMMARY

The summary of this device is not intended to describe each illustrated embodiment or every possible implementation of the device. The present disclosure generally relates to a portable oxygen and carbon dioxide analyzer for emissions testing and system for performing oxygen and carbon dioxide emissions analysis. Additional features and advantages of the device will be set forth in the description that follows, and in part will be obvious from the description, or may be learned by the practice of the disclosure. The features and advantages of the device may be realized and obtained by means of the instruments and combinations particularly pointed out in the appended claims. These and other features of the device will become more fully apparent from the following description and appended claims or may be learned by the practice of the disclosure as set forth hereinafter.

The disclosure relates to a digitally controlled analyzer capable of taking readings from internal oxygen and carbon dioxide sensors. The readings are processed by a programmed digital microcontroller by applying corrections to account for known calibration gas span and zero values and current temperature and pressure values. The readings can be communicated, at minimum, via a display on the front panel and a buffer, which produces voltage and/or current outputs which may be recorded by a chart recorder and/or external data logger.

The disclosure may be powered by AC line voltage, which is transformed by an internal or external power supply to low direct current (DC) voltage(s) to power the microcontroller and buffer. The microcontroller employs a so called “real time clock” (RTC), which utilizes a small battery to maintain current date and time values when the analyzer is powered down. It is within the scope of the disclosure to use a battery for non-continuous use of the device disclosed herein or to maintain operation of the device during temporary power failure conditions.

The microcontroller has nonvolatile memory to which data can be written for permanent storage. This memory may be in the form of a Secure Digital (SD) type card. The data may be in the form of instantaneous oxygen and carbon dioxide readings or readings averaged over a user specified time period, e.g. one-minute averages. Files containing the recorded readings are date and time stamped using information from the real time clock. The files of readings may be retrieved by sending the readings to the display; through digital communication with a computer, e.g. through a universal serial bus port; or by transferring an SD card.

The microcontroller is programed to take readings from the sensors, apply correction factors to the readings, and communicate the corrected readings at minimum to the display and one or more analog outputs. The program also has menus which can be accessed by the user via user interface keys on the front panel of the analyzer. The menus allow the user to control the analyzer functions such as setup, calibration, trouble shooting, and data logging. A so called “touch screen” interface could also be employed.

The oxygen and carbon dioxide sensors are secured in a leak tight housing. Gas, which is potentially dangerous, is conveyed into and out of the housing through industrial grade, i.e. Swagelok® type, fittings. These fittings are not prone to leakage so the sample can be conveyed to and away from the sensors and reliably vented away from the user.

The disclosure relates to a compact and lightweight device so that it may be transported to a sampling location with minimal effort.

The device disclosed herein may or may not employ radio communication, e.g., Wi-Fi or Bluetooth, to allow remote digital access to data logging and control features.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. Advantages of the disclosure will become better understood with regard to the following description and accompanying drawings where:

FIG. 1 is an orthogonal front view of an example embodiment of a front panel layout of the oxygen and carbon dioxide analyzer;

FIG. 2 is an orthogonal rear view of an example embodiment of a rear panel layout of the analyzer;

FIG. 3 is a sectional view of an example embodiment of the internal electrical and electronic components of the analyzer; and

FIGS. 4A-4C are sectional views of an example embodiment of a sensor block, which holds the sensors in place and conducts gas to and away from the sensors.

### DETAILED DESCRIPTION

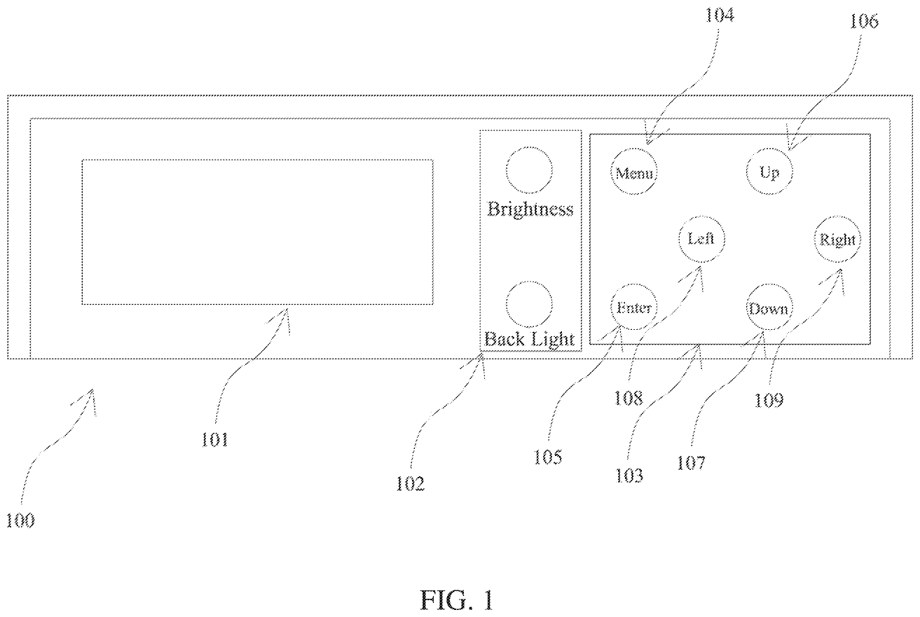

FIG. 1 is an orthogonal front view of an example embodiment of a front panel 100 layout of the oxygen and carbon dioxide analyzer. The front panel 100 shown has a display 101, analog potentiometers 102 to control the visibility of the display 101, and user interface buttons 103. The display 101 has a four-line 20-character display that is used to display current oxygen and carbon dioxide readings, menu items, and various values. The analog potentiometers 102 allow the user to control of visibility by increasing or decreasing brightness and backlight via buttons or dials. The user interface buttons 103 allow the user to enter menus to control the operations of the analyzer device. One of the user interface buttons 103 is a “Menu” button 104; pressing this button allows the user to enter the menu, pressing it a second time at any point while in the menu allows the user to escape the menu. A second user interface button 103 is the “Enter” button 105; pressing this button allows the user to select a menu, select a value to edit, or to save a value once edited. The remaining four user interface buttons 103 allow the user to navigate the interface by scrolling “Up” 106, “Down” 107, “Left” 108, and “Right” 109 or for editing digits “Up” 106 or “Down” 107. Other user interface schemes are within the scope of this disclosure relating to an analyzer device. Modern displays can be so called “touchscreens” such that the display 101, visibility controls (such as, for example, potentiometers 102), and user interface buttons 103 are all contained in the display 101 but for simplicity the device was constructed as shown and for clarity this layout is reproduced here. The use of a touchscreen interface is within the scope of this analyzer device.

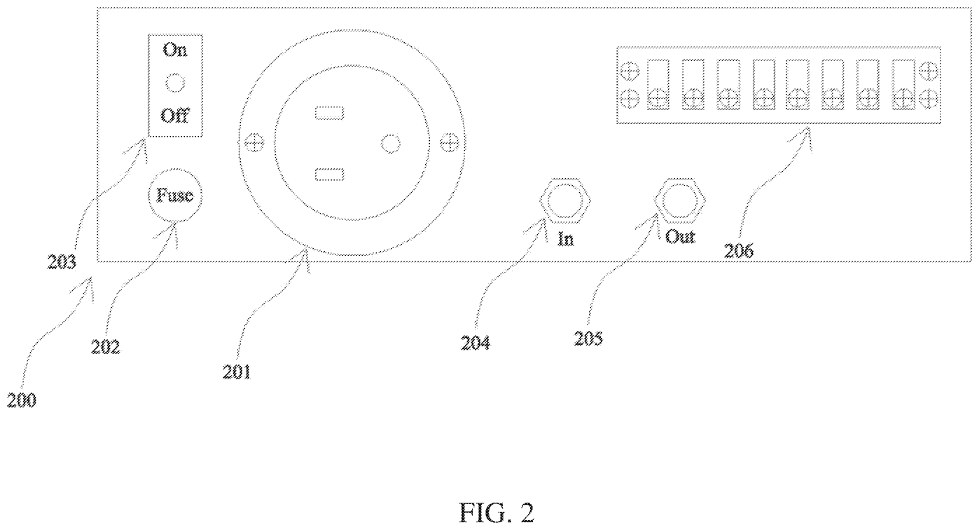

FIG. 2 is an orthogonal rear view of an example embodiment of a rear panel 200 of the analyzer. The rear panel 200 shown has a power inlet 201, a fuse holder 202, an on/off switch 203, a gas inlet fitting 204, a gas outlet fitting 205, and an electrical terminal block 206. The gas inlet fitting 204 and gas outlet fitting 205 are both industrial grade compression fittings, i.e. Swagelok® type. It is within the scope of this disclosure to use any fitting which provides a leak tight seal and provides a rugged connection which prevents the tubing from becoming disconnected. The electrical terminal block 206 provides connection points for analog outputs for an external data logger. It is within the scope of this disclosure to replace the fuse holder 202 shown with an appropriately sized circuit breaker. It is within the scope of this disclosure to use other forms of connectors instead of the electrical terminal block 206. It is within the scope of this disclosure to use another type of power inlet 201 than the one shown. It is within the scope of this disclosure to use a power inlet, which incorporates the power inlet 201, fuse holder 202 or circuit breaker, and on/off switch 203 as a single unit or any of these components 201, 202, and/or 203 as a single unit. Items described as being on the rear panel 200 can be put on the front panel 100 and vice-versa or oriented in any other way and be within the scope of this disclosure.

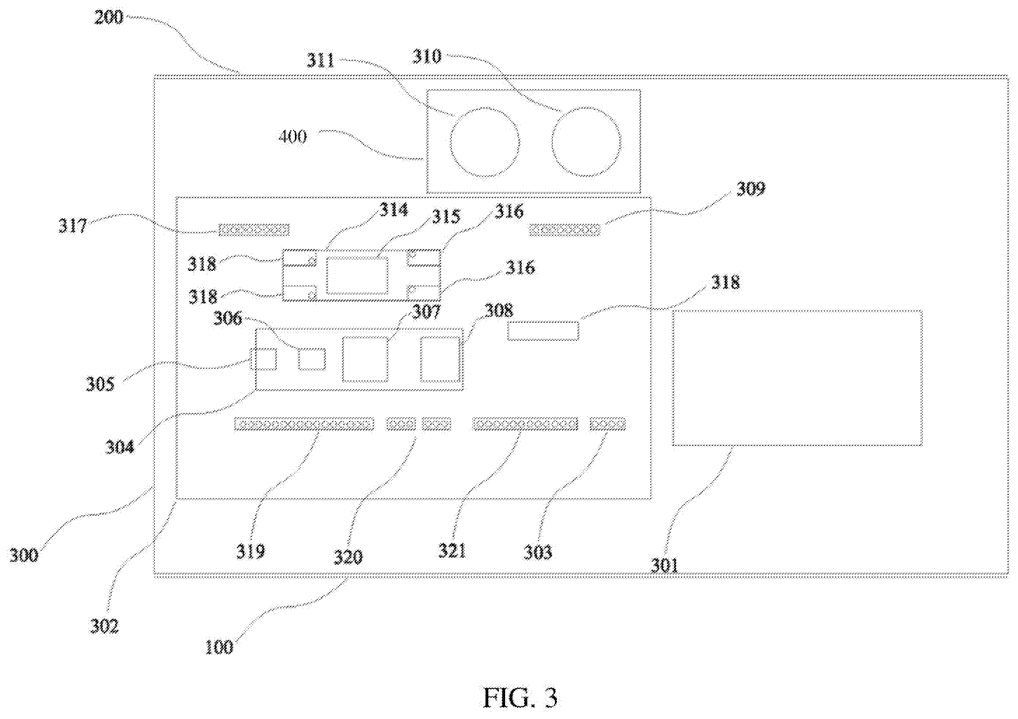

FIG. 3 is a sectional view of an example embodiment of the interior 300 of the analyzer. AC line voltage is conducted from the on/off switch 203, not shown in this diagram for clarity on the rear panel 200, to the power supply 301 where it is transformed down to 5 volts and 12 volts DC. The power supply 301 is a commercially available, off the shelf, component. From the power supply 301 the voltage is conducted to the main circuit board 302 through the Single Row Pin (SRP) connector 303. One of the pins on the SRP connector 303 is supplied with 12 volts, another pin 5 volts, and two pins are grounds for the 12 and 5 volt pins. The main circuit board 302 was made for the illustrated embodiment of the analyzer device; circuit boards of other designs that meet the needs of the analyzer device are within the scope of this disclosure. The use of an external power supply is within the scope of this disclosure.

Five volt DC power may be conducted from the SRP connector 303 through the main circuit board 302 to the microcontroller 304. The microcontroller 304 is connected to the main circuit board 302 through two 24 pin SRP connectors, which are not shown for clarity. The microcontroller 304 that may be used is a commercially available “Teensy 3.5” microcontroller, which, among other onboard components, has 62 general purpose input/output (I/O) pins and solder points, not shown for clarity, of which two may be 12 bit digital to analog capable; many other single purpose I/O pins and solder points, not shown for clarity; a USB port 305; power regulator 306; ARM Cortex-M4 processor 307; and a micro SD card port 308. A micro SD card in the micro SD Card Port 308 is used to store data for internal data logging. The microcontroller 304 uses 3.3 volt logic, which is supplied by the power regulator 306. Several of the special purpose outputs, not shown, provide 3.3 volt output for use by external components and one of these outputs is used to feed 3.3 volt power back into the main circuit board 302. Other microcontrollers, which meet the needs of the analyzer device are within the scope of this disclosure. Incorporating the one or more of the needed components of the microcontroller 304 into the main circuit board 302 is within the scope of this disclosure.

The SRP connector 309 is used to connect the oxygen sensor 310 and carbon dioxide sensor 311 to the microcontroller 304 via the main circuit board 302. One of the pins on the SRP connector 309 is supplied 5 volts from the SRP connector 303, another pin 3.3 volts from the power regulator 306, two pins on the SRP connector 309 are grounds, and four of the pins on the SRP connector 309 are data transmission pins and connected to four of the general purpose I/O pins on the microcontroller 304.

The oxygen sensor 310 used in the analyzer device is a commercially available LuminOx Optical Oxygen Sensor. The oxygen sensor 310 has onboard sensors for measuring the pressure and temperature of the gas stream. The oxygen sensor 310 is powered by b 5 volts DC and uses Universal Asynchronous Receiver-Transmitter (UART) communications hardware to communicate the measured oxygen concentration, pressure, and temperature digitally to the microcontroller 304. Wire jumpers, not shown for clarity, are used to conduct power and transmit data between the oxygen sensor 310 and the SRP connector 309. The oxygen sensor 310 is a non-destructive type sensor meaning that it does not change any gas species during the measurement process. Oxygen sensors other than the oxygen sensor 310 chosen for use in the analyzer device and other pressure and temperature measurement schemes are within the scope of this disclosure.

The carbon dioxide sensor 311 that may be used in the analyzer device is a commercially available ExplorIR-M Carbon Dioxide Sensor. The carbon dioxide sensor 311 is powered by 3.3 volts DC and uses UART hardware to communicate the measured carbon dioxide concentration digitally to the microcontroller 304. Wire jumpers, not shown for clarity, are used to conduct power and transmit data between the carbon dioxide sensor 311 and the SRP connector 309. The carbon dioxide sensor 311 is also a non-destructive type sensor. Carbon dioxide sensors other than the carbon dioxide sensor 311 chosen for use in the analyzer device are within the scope of this disclosure.

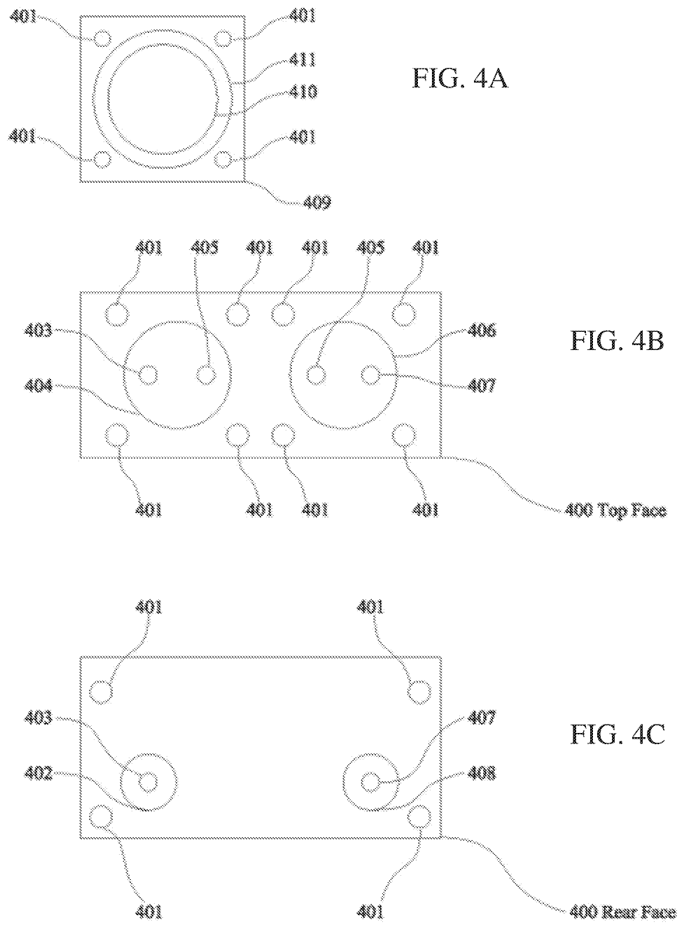

The oxygen sensor 310 and carbon dioxide sensor 311 are held in a leak tight sensor block, such as sensor block 400 shown in FIGS. 4A-4C, that uses O-rings between the sensor block 400 and the oxygen sensor 310 and carbon dioxide sensor 311 to ensure a positive seal. The sensor block 400 used in the analyzer device is a purpose made, 3D printed, ABS block that in addition to holding the oxygen sensor 310 and carbon dioxide sensor 311, also connects to the gas inlet fitting 204 and the gas outlet fitting 205, which are not shown in this diagram for clarity, in a positively sealed manor. Gas to be analyzed enters the gas inlet fitting 204, is channeled to the oxygen sensor 310 for analysis, is then channeled to the carbon dioxide sensor 311 for analysis, and then channeled to the gas outlet fitting 205 to be conducted away from the measurement area. Schemes that hold the oxygen sensor 310 and carbon dioxide sensor 311 as well as temperature and pressure sensors other than the sensor block 400 used in the analyzer device are within the scope of this disclosure.

The analog output buffer 314 incorporated in the analyzer device has two functions: first it prevents shorted analog outputs from overloading the microcontroller 304 and causing permanent damage; second it amplifies the analog outputs so that a 10 volt full scale output for both the oxygen and carbon dioxide readings can be given. One volt and 10 volt full scale analog outputs are common on many analyzers and users are usually set up for one or the other so this analyzer device was made to produce both of these full scale outputs for both the oxygen and carbon dioxide measurements.

The main component of the analog output buffer 314 may be an LM2902N Quad Operational Amplifier 315, which is four Operational Amplifiers (OpAmps) on one chip. The LM2902N Quad Operational Amplifier 315 is powered by 12 volts DC supplied from the SRP connector 303. To simplify the explanation of the function of the analog output buffer 314 the discussion will be limited to the treatment of the oxygen measurement; the carbon dioxide measurement is treated identically.

First the oxygen concentration is determined by the oxygen sensor 310 and digitally transmitted to the microcontroller 304. The microcontroller 304 corrects the received concentration based on measurements of known calibration gas values and changes in temperature and pressure since the calibration gasses were initially analyzed. The analog output pin designated for the oxygen measurement on the microcontroller 304 is made to produce a voltage which is linearly proportional to the corrected oxygen concentration where a zero oxygen concentration is represented with a zero volt output and a full scale (25%) oxygen concentration is represented with a 3.3 volt output. A voltage divider circuit, i.e. two resistors in series, not shown, is used to divide the produced voltage down to a full-scale divided voltage of 1 volt. A variable resistor 316 is used to adjust the divided voltage to exactly the desired value. The divided voltage is introduced to the input on one of the OpAmps on the LM2902N Quad Operational Amplifier 315, which is wired as a unity gain follower. The output of this OpAmp is supplied to one of the pins on the SRP connector 317 and to the input of a second OpAmp on the LM2902N Quad Operational Amplifier 315. The second OpAmp is wired for a gain of 10 with a variable resistor 316 used to adjust the gain to exactly the desired value. The output of the second OpAmp is conducted to a second pin on the SRP connecter 317. Jumpers, not shown for clarity, conduct the analog voltages from the SRP connector 317 to the electrical terminal block 206. While this scheme produces 1 and 10 volt full scale analog outputs other schemes could be used to produce these or other voltage or current outputs and are within the scope of this disclosure.

The real time clock 318 is used to keep track of the date and time when the analyzer device is powered down; date and time stamps are used for internal data logging purposes. The SRP connector 319 is used to supply power and data to the display 101. The SRP connector 320 is used to connect the potentiometers 102. The outputs of the potentiometers 102 are fed back to the main circuit board 302 from pins on the SRP connector 320. The SRP connector 321 is used to connect the user interface buttons 103 to the main circuit board 302.

FIGS. 4A-4C are sectional views of an example embodiment of a sensor block 400. The sensor block may be 3d printed from ABS plastic. FIG. 4A is a sectional view of an example embodiment of a flange 409. FIG. 4B is a sectional view of the “top face” of sensor block 400. FIG. 4C is a sectional view of the “rear face” of sensor block 400.

FIGS. 4A-4C may be 3D printed and used to hold the oxygen sensor 310, carbon dioxide sensor 311, the gas inlet fitting 204, the gas outlet fitting 205, and to conduct the gas being analyzed from the gas inlet fitting 204 to the oxygen sensor 310 and from the oxygen sensor 310 to the carbon dioxide sensor 311 and from the carbon dioxide sensor 311 to the gas outlet fitting 205. The sensor block 400 has four screw holes 401 in the rear face used to secure the sensor block 400 to the rear panel 200. These screw holes 401 are sized to take brass inserts, not shown for clarity, which are threaded on the inside and knurled on the outside to provide a more robust attachment than simply threading the plastic of the sensor block 400. The screw holes 401 are illustrated in FIG. 4A from a cross sectional perspective, in FIG. 4B from forward view “top face” perspective, and in FIG. 4C from a rear view “rear face” perspective.

The inlet port 402, as illustrated in FIG. 4C, is threaded and receives the gas inlet fitting 204. In the center of the inlet port is an “L” shaped channel 403, as illustrated in both FIGS. 4B and 4C, conducts the gas being analyzed from the gas inlet fitting 204 to the oxygen sensor port 404 as shown in FIG. 4B. From the oxygen sensor port 404 a “U” shaped channel 405 conducts the gas being analyzed to the carbon dioxide sensor port 406, illustrated in FIG. 4B. Another “L” shaped channel 407, shown in FIGS. 4B and 4C, conducts the gas which has now been analyzed from the carbon dioxide sensor port 406 to the outlet fitting port 408 shown in FIG. 4C. The outlet fitting port 408 is threaded and holds the gas outlet fitting 205.

The screw holes 401 on the top face of the sensor block 400 are also sized to take the same brass inserts as the screw holes 401 on the rear face of the sensor block 400, the screw holes 401 are shown in FIGS. 4A, 4B, and 4C. The screw holes 401 in the top face of the sensor block 400 align with the screw holes 401 in the flange 409 illustrated in FIG. 4A; the flange 409 is also 3d printed from ABS plastic. The sensor block 400 uses two identical flanges 409; one flange 409 is used to hold the oxygen sensor 310 in place and the second flange 409 holds the carbon dioxide sensor 311 in place. The center hole 410 in the flange 409 is sized to fit around the circumference of the oxygen sensor 310 and carbon dioxide sensor 311 (20 mm) A groove 411 is made into the flange 409 that snugly holds an O-ring, not shown for clarity, which, when the flange 409 is tightened down onto sensor block 400, holds the oxygen sensor 310 or carbon dioxide sensor 311 rigidly in place and provides an airtight seal between the oxygen sensor 310 or carbon dioxide sensor 311 and the sensor block 400 as illustrated by FIG. 4A with respect to FIGS. 4B and 4C. One or more additional O-rings, for example two additional O-rings, which are not shown for clarity, may be placed at the bottom of the oxygen sensor port 404 and carbon dioxide sensor port 406, which provides another seal between the face of the oxygen sensor 310 or carbon dioxide sensor 311 and the sensor block 400. Thus, each oxygen sensor 310 and carbon dioxide sensor 311 has a double seal to prevent the potentially dangerous gas being analyzed from escaping or ambient air from diluting the sample.

Although the device is amenable to various modifications and alternative forms, specifics thereof have been shown by way of example in the drawings and will be described in detail such that the disclosure will be thorough and complete, and will fully convey the scope of the claimed device to those skilled in the art. However, it should be understood, that the disclosure is not to limit the device to the particular embodiments described. On the contrary, the intention is to cover all modifications, equivalents, and alternatives falling within the spirit and scope of the device as defined by the appended claims.

### EXAMPLES

The following are examples of various embodiments of the disclosure.

Example 1 is an apparatus for determining concentrations of oxygen and carbon dioxide from combustion sources. The apparatus includes a housing that is sized for portability; an analog voltage output; a microprocessor; an oxygen sensor in electrical communication with the microprocessor; a carbon dioxide sensor in electrical communication with the microprocessor; a plurality of fittings for connecting tubing to the housing; and an A/C power source.

Example 2 includes the apparatus of for determining concentrations of oxygen and carbon dioxide from Example 1, wherein the housing is compact and weighs less than one kilogram.

Example 3 includes the apparatus of for determining concentrations of oxygen and carbon dioxide from any of Examples 1-2, wherein the plurality of fittings comprises an inlet fitting and an outlet fitting.

Example 4 includes the apparatus of for determining concentrations of oxygen and carbon dioxide from any of Examples 1-3, wherein the apparatus comprises a sensor block comprising a plurality of openings, wherein a first of the plurality of openings houses and secures the oxygen sensor and a second of the plurality of openings houses and secures the carbon dioxide sensor.

Example 5 includes the apparatus of for determining concentrations of oxygen and carbon dioxide from any of Examples 1-4, wherein the sensor block is made of ABS plastic and is located inside the housing.

Example 6 includes the apparatus of for determining concentrations of oxygen and carbon dioxide from any of Examples 1-5, wherein the microprocessor receives a one or more digital outputs from the oxygen sensor and the carbon dioxide sensor, which are then provided as inputs to a correction algorithm.

Example 7 includes the apparatus of for determining concentrations of oxygen and carbon dioxide from any of Examples 1-6, wherein the correction algorithm uses calibration gases comprising oxygen and carbon dioxide to calculate span values for use in creating correction values; or the correction algorithm uses nitrogen or a gas mixture that does not contain oxygen or carbon dioxide to determine a zero value.

Example 8 includes the apparatus of for determining concentrations of oxygen and carbon dioxide from any of Examples 1-7, wherein the correction algorithm is programmed using a programming language ARDUINO IDE.

Example 9 includes the apparatus of for determining concentrations of oxygen and carbon dioxide from any of Examples 1-8, wherein the correction algorithm creates one or more correction values that are offset from a known temperature by measuring the temperature of the combustion gases when values of the calibration gases are measured, and if the temperature drifts during measurement of the combustion gases the algorithm corrects the drift in temperature.

Example 10 includes the apparatus of for determining concentrations of oxygen and carbon dioxide from any of Examples 1-9, wherein the correction algorithm creates one or more correction values that are offset from a known pressure by measuring the pressure of the combustion gases when values of the calibration gases are measured, and if the pressure drifts during measurement of the combustion gases the algorithm corrects the drift in pressure.

Example 11 includes the apparatus of for determining concentrations of oxygen and carbon dioxide from any of Examples 1-10, wherein the apparatus further comprises a real time clock (RTC) employed by the microcontroller and powered by a battery to maintain current date and time values when the device is powered down.

Example 12 includes the apparatus of for determining concentrations of oxygen and carbon dioxide from any of Examples 1-11, wherein the microcontroller has a non-volatile memory to which data can be written for permanent storage.

Example 13 includes the apparatus of for determining concentrations of oxygen and carbon dioxide from any of Examples 1-12, wherein the non-volatile memory is a Secure Digital (SD) card.

Example 14 is a method for determining concentrations of oxygen and carbon dioxide from combustion sources. The method includes measuring oxygen and carbon dioxide concentrations using a device comprising a housing that is sized for portability; an analog voltage output; a microprocessor; an oxygen sensor in electrical communication with the microprocessor; a carbon dioxide sensor in electrical communication with the microprocessor; a plurality of fittings for connecting tubing to the housing; and an A/C power source. The method further includes converting digital readings from the microcontroller to proportional analog voltage outputs. The method further includes transforming alternating current line voltage from internal or external power sources to low direct current voltage to provide power for the microcontroller and a buffer. The method further includes processing oxygen and carbon dioxide readings using the microcontroller programmed with one or more calibration algorithms. The method further includes applying correction factors to oxygen and carbon dioxide readings. The method further includes communicating corrected oxygen and carbon dioxide readings to a display or one or more analog outputs. The method further includes displaying oxygen and carbon dioxide readings on a display; and buffering voltage and/or current outputs.

Example 15 includes the method for determining concentrations of oxygen and carbon dioxide from combustion sources of Example 14, wherein the method further comprises recording voltage and/or current outputs using a chart recorder and/or external data logger.

Example 16 includes the method for determining concentrations of oxygen and carbon dioxide from combustion sources of any of Examples 14-15, wherein the method further comprises maintaining current date and time values when powered down.

Example 17 is a method for determining concentrations of oxygen and carbon dioxide from combustion sources. The method includes analyzing gas entering an inlet fitting in a device comprising: a housing that is sized for portability; an analog voltage output; a microprocessor; an oxygen sensor in electrical communication with the microprocessor; a carbon dioxide sensor in electrical communication with the microprocessor; a plurality of fittings for connecting tubing to the housing; and an A/C power source. The method further includes analyzing gas that has been channeled to the oxygen sensor. The method further includes analyzing gas that has been channeled to the carbon dioxide sensor. The method further includes digitally transmitting oxygen and carbon dioxide concentrations to the microcontroller. The method further includes correcting digitally transmitted concentrations, via the microcontroller, using measurements of known calibration gas values and changes in temperature and pressure. The method further includes producing a voltage that is linearly proportional to the corrected oxygen or carbon dioxide concentration utilizing an analog output pin designated for oxygen or carbon dioxide measurement on the microcontroller; and discharging gas through an outlet following analysis.

The foregoing description has been presented for the purposes of illustration and description. It is not intended to be exhaustive or to limit the disclosure to the precise form disclosed. Many modifications and variations are possible in light of the above teaching. Further, it should be noted that any or all of the aforementioned alternate implementations may be used in any combination desired to form additional hybrid implementations of the disclosure.

Further, although specific implementations of the disclosure have been described and illustrated, the disclosure is not to be limited to the specific forms or arrangements of parts so described and illustrated. The scope of the disclosure is to be defined by the claims appended hereto, any future claims submitted here and in different applications, and their equivalents.

What is claimed is:

1. An apparatus for determining concentrations of oxygen and carbon dioxide from combustion sources comprising:
a housing that is sized for portability;
an analog voltage output;
a microprocessor;
an oxygen sensor in electrical communication with the microprocessor;
a carbon dioxide sensor in electrical communication with the microprocessor;
a plurality of fittings for connecting tubing to the housing; and
an A/C power source.

2. The apparatus of claim 1, wherein the housing is compact and weighs less than one kilogram.

3. The apparatus of claim 1, wherein the plurality of fittings comprises an inlet fitting and an outlet fitting.

4. The apparatus of claim 1, wherein the apparatus comprises a sensor block comprising a plurality of openings, wherein a first of the plurality of openings houses and secures the oxygen sensor and a second of the plurality of openings houses and secures the carbon dioxide sensor.

5. The apparatus of claim 4, wherein the sensor block is made of ABS plastic and is located inside the housing.

6. The apparatus of claim 1, wherein the microprocessor receives a one or more digital outputs from the oxygen sensor and the carbon dioxide sensor, which are then provided as inputs to a correction algorithm.

7. The apparatus of claim 6, wherein the correction algorithm uses calibration gases comprising oxygen and carbon dioxide to calculate span values for use in creating correction values; or the correction algorithm uses nitrogen or a gas mixture that does not contain oxygen or carbon dioxide to determine a zero value.

8. The apparatus of claim 7, wherein the correction algorithm creates one or more correction values that are offset from a known temperature by measuring the temperature of the combustion gases when values of the calibration gases are measured, and if the temperature drifts during measurement of the combustion gases the algorithm corrects the drift in temperature.

9. The apparatus of claim 6, wherein the correction algorithm creates one or more correction values that are offset from a known pressure by measuring the pressure of the combustion gases when values of the calibration gases are measured, and if the pressure drifts during measurement of the combustion gases the algorithm corrects the drift in pressure.

10. The apparatus of claim 1, further comprising a real time clock (RTC) employed by the microcontroller and powered by a battery to maintain current date and time values when the device is powered down.

11. The apparatus of claim 1, wherein the microcontroller has a non-volatile memory to which data can be written for permanent storage.

12. The apparatus of claim 11, wherein the non-volatile memory is a Secure Digital (SD) card.

13. A method for determining concentrations of oxygen and carbon dioxide from combustion sources comprising:
measuring oxygen and carbon dioxide concentrations using a device comprising:
a housing that is sized for portability;
an analog voltage output;
a microprocessor;
an oxygen sensor in electrical communication with the microprocessor;
a carbon dioxide sensor in electrical communication with the microprocessor;
a plurality of fittings for connecting tubing to the housing; and
an A/C power source;
converting digital readings from the microcontroller to proportional analog voltage outputs;
transforming alternating current line voltage from internal or external power sources to low direct current voltage to provide power for the microcontroller and a buffer;
processing oxygen and carbon dioxide readings using the microcontroller programmed with one or more calibration algorithms;
applying correction factors to oxygen and carbon dioxide readings;
communicating corrected oxygen and carbon dioxide readings to a display or analog output;
displaying oxygen and carbon dioxide readings on a display; and
buffering voltage and/or current outputs.

14. The method of claim 13, wherein the method further comprises recording voltage and/or current outputs using a chart recorder and/or external data logger.

15. The method of claim 13, wherein the method further comprises maintaining current date and time values when powered down.

16. A method for determining concentrations of oxygen and carbon dioxide from combustion sources comprising:
analyzing gas entering an inlet fitting in a device comprising:
a housing that is sized for portability;
an analog voltage output;
a microprocessor;
an oxygen sensor in electrical communication with the microprocessor;
a carbon dioxide sensor in electrical communication with the microprocessor;
a plurality of fittings for connecting tubing to the housing; and
an A/C power source;
analyzing gas that has been channeled to the oxygen sensor;
analyzing gas that has been channeled to the carbon dioxide sensor;
digitally transmitting oxygen and carbon dioxide concentrations to the microcontroller;
correcting digitally transmitted concentrations, via the microcontroller, using measurements of known calibration gas values and changes in temperature and pressure;
producing a voltage that is linearly proportional to the corrected oxygen or carbon dioxide concentration utilizing an analog output pin designated for oxygen or carbon dioxide measurement on the microcontroller; and
discharging gas through an outlet following analysis.
